(19) United States
(12) Patent Application Publication
(10) Pub. No.: US 2026/0333522 A1
(43) Pub. Date: Oct. 22, 2026

(54) FIRE PREVENTION MAT

(71) Applicant: DOCTORSUPPLY CO., LTD., Seoul (KR)

(72) Inventor: SHUNG KYU AHN, Seoul (KR)

(21) Appl. No.: 18/852,488

(22) PCT Filed: Dec. 27, 2023
(86) PCT No.: PCT/KR2023/021680

§ 371 Date: Sep. 29, 2024

(51) Int. Cl. H05B 3/34; H05B 3/12; H05B 3/36

(52) U.S. Cl. CPC H05B 3/342; H05B 3/12; H05B 3/36; H05B 2203/014; H05B 2203/016

(57) ABSTRACT

The present disclosure provides a fire prevention mat comprising: a base fabric (110) provided with a control device (140) for controlling supply of direct current power; a plurality of heating lines (120) that are coupled to the base fabric (110) and generate heat when power is applied thereto; and an electrode part (202) including a plurality of conductive lines (250) configured to make electrical contact with the heating lines (120), and a plurality of branch conductive lines (260) provided in the plurality of conductive lines (250), which divide copper wires forming the plurality of conductive lines (250) into a predetermined number of strands to branch them and connect the branched plurality of conductive lines (250) to each other to be electrically connected.

### TECHNICAL FIELD

The present disclosure relates to a fire prevention mat, and more particularly, to a fire prevention mat comprised of a plurality of conductive lines wherein the conductive line strands located at the top and bottom are split to form branch conductive lines in which the plurality of conductive line strands branch off from each other, and wherein the branch conductive lines formed at opposite positions among the branch conductive lines are connected to each other so that all of the plurality of conductive lines conduct electricity, thereby maximizing the contact area between the plurality of conductive lines and a heating line to prevent poor contact with the heating line from occurring, and also preventing a fire from occurring due to poor contact with the heating line even if some of the conductive line strands are damaged or broken.

### BACKGROUND ART

A Typical thermal mat includes a heating mat that generates heat when power is supplied, and are used in various fields such as being applied to mattresses for sleeping or installed in vehicle seats.

Such a thermal mat is comprised of heating lines for heat generation, and copper (copper wire) is used as most of the heating lines, problems such as short circuits due to hardening caused by continuous heat switching or oxidation of the copper may occur, which may lead to problems such as poor contact with power lines and short circuits due to the poor contact.

In particular, the series copper wire used in the thermal mat according to conventional technology is woven into the fabric of the mat, such as a thin non-woven fabric or similar sheet, causing abnormal overheating due to bunching or overlapping of the heating line.

Therefore, a thermal mat comprised of a heating line made of carbon fiber and a copper wire that supplies power to the heating line has been developed, but in the case of the carbon fiber heating line according to the conventional technology, not only is sufficient heating amount not secured due to the heating limit of the carbon fiber, but also there is a problem of being easily broken due to its weak tensile strength.

In addition, there is a problem that with repeated use of the thermal mat, the copper wire would become separated from the fabric of the mat, causing poor contact with the heating line, and if a short circuit due to poor contact between the copper wire and the heating line occurs and a fire due to the short circuit occurs, part or all of the mat is damaged or destroyed, which ultimately causes problems such as a serious decrease in product reliability and a failure to provide safety.

In addition, in the case of conventional thermal mats, if some strands of the copper conductive lines are damaged or broken due to long-term use or external forces such as impact, the resistance is concentrated on the remaining conductive lines, causing a rapid localized heating which may cause burns to the user or cause a fire, resulting in a decrease in product reliability and serious safety issues.

In addition, the conventional thermal mat is difficult to wash through general washing methods, such as water washing or hand washing because some of the conductive strands may be damaged or broken, and is vulnerable to stress caused by repeated use.

In the case where the conventional thermal mat is damaged or broken due to a fire, additional costs are incurred for maintenance and repair, resulting in an increase in the management cost.

### DETAILED DESCRIPTION OF INVENTION

### Technical Problems

To address such issues, the present disclosure has been conceive based on the background art described above, and provides a fire prevention mat comprised of a plurality of conductive lines wherein the conductive line strands located at the top and bottom are split to form branch conductive lines in which the plurality of conductive line strands branch off from each other, and wherein the branch conductive lines formed at opposite positions among the branch conductive lines are connected to each other so that all of the plurality of conductive lines are electrically connected, thereby maximizing the contact area between the plurality of conductive lines and a heating line to prevent poor contact with the heating line from occurring, and also preventing a fire from occurring due to poor contact with the heating line even if some of the conductive line strands are damaged or broken.

In addition, the present disclosure provides a fire prevention mat wherein a plurality of conductive lines are configured such that they are all electrically connected through branch conductive lines, so that even if only one strand of the branch conductive lines maintains contact with a heating line, stable and continuous power supply is possible, thereby preventing overheating from occurring due to concentration of resistance on the conductive line with poor contact and preventing the occurrence of a fire.

Further, the present disclosure provides a fire prevention mat that can prevent oxidation of a conductive line that supplies power to a heating line by coating tin on the surface of copper having a thin diameter.

Furthermore, the present disclosure provides a fire prevention mat wherein a plurality of conductive lines coated with tin are connected to each other through branch conductive lines to form an integrated conductive line, thereby providing sufficient resistance to stress caused by repeated use and improving the weaving property with the base fabric of the mat, which minimizes the defect rate of the product and the damage or breakage of the conductive lines even when washing is performed through general washing methods, such as hand washing or water washing.

### Technical Solution

In accordance with one embodiment of the present disclosure, a fire prevention mat comprises: a base fabric 110 provided with a control device 140 for controlling supply of direct current power; a plurality of heating lines 120 that are coupled to the base fabric 110 and generate heat when power is applied thereto; and an electrode part 202 including a plurality of conductive lines 250 configured to make electrical contact with the heating lines 120, and a plurality of branch conductive lines 260 provided in the plurality of conductive lines 250, which divide copper wires forming the plurality of conductive lines 250 into a predetermined number of strands to branch them and connect the branched plurality of conductive lines 250 to each other to be electrically connected.

In accordance with one embodiment of the present disclosure, the electrode part 202 includes: a first electrode part 210 comprised of the plurality of conductive lines 250 and the plurality of branch conductive lines 260, provided in a central portion of the base fabric 110, and configured to contact the central portion of the heating line 120; a second electrode part 220 which is provided on one side or both sides of the base fabric 110 or is provided on a peripheral surface thereof, and is configured to contact both ends of the heating line 120; and a plurality of first insulating cover parts 230 provided on the first electrode part 210 at positions where the heating line 120 and the plurality of conductive lines 250 come into contact to secure the first electrode part 210 to the base fabric 110.

In accordance with one embodiment of the present disclosure, the electrode part 202 includes a second insulating cover part 240 comprised of the plurality of conductive lines 250 and the plurality of branch conductive lines 260 and provided between the plurality of first insulating cover parts 230 to provide insulation against the current flowing through the first electrode part 210.

In accordance with one embodiment of the present disclosure, the plurality of conductive lines 250 are comprised of a plurality of tin-coated copper wires.

In accordance with one embodiment of the present disclosure, each of the branch conductive lines 260 branches from each of the plurality of conductive lines 250 into a first branch conductive line 260a and a second branch conductive line 260b.

In accordance with one embodiment of the present disclosure, the first insulating cover part 230 includes: an electrode contact part 310 that allows the heating line 120 and the plurality of conductive lines 250 to be electrically contacted while being orthogonal to each other; a first electrode covering part 320 that is provided on each of upper and lower sides of the electrode contact part 310 and covers the heating line 120 and the plurality of conductive lines 250 to surround them; a branch conductive line connecting part 330 that is provided on each of upper and lower sides of the first electrode covering part 320 and connects the plurality of branch conductive lines 260 formed on the plurality of conductive lines 250; and a second electrode covering part 340 that is provided on each of upper and lower sides of the branch conductive line connecting part 330 and covers the plurality of conductive lines 250 extending from ends of the plurality of branch conductive lines 260 to surround them.

In accordance with one embodiment of the present disclosure, the second insulating cover part 240 includes: a first electrode covering part 320 that covers the heating line 120 and the plurality of conductive lines 250; and a second electrode covering part 340 that is provided on a lower side of the first electrode covering part 320 and covers the plurality of conductive lines 250 that extend from ends of the plurality of branch conductive lines 260.

### Effect of Invention

According to the embodiment of the present disclosure, since the plurality of conductive lines are configured to be all electrically connected through the branch conductive lines, the contact area between the plurality of conductive lines and the heating line is maximized, thereby preventing poor contact with the heating line and of preventing a fire from occurring due to poor contact with the heating line even if some of the conductive line strands are damaged or broken.

In addition, according to the embodiment of the present disclosure, since the plurality of conductive lines are configured to be all electrically connected through the branch conductive lines, even if only one strand of the branch conductive lines maintains contact with the heating line, stable and continuous power supply is possible, thereby preventing overheating from occurring due to resistance being concentrated on the conductive line with poor contact and preventing the occurrence of a fire.

Further, according to the embodiment of the present disclosure, by coating tin on the surface of copper having a thin diameter, it is possible to prevent oxidation of the conductive line that supplies power to the heating line.

Furthermore, according to the embodiment of the present disclosure, the plurality of conductive lines coated with tin are connected to each other through the branch conductive lines to form an integrated conductive line, thereby providing sufficient resistance to stress caused by repeated use and improving the weaving property with the base fabric of the mat, which minimizes the defect rate of the product and the damage or breakage of the conductive lines even when washing is performed through general washing methods, such as hand washing or water washing.

### BRIEF DESCRIPTION OF THE DRAWING

FIG. 1 is a schematic diagram of a fire prevention mat according to one embodiment of the present disclosure.

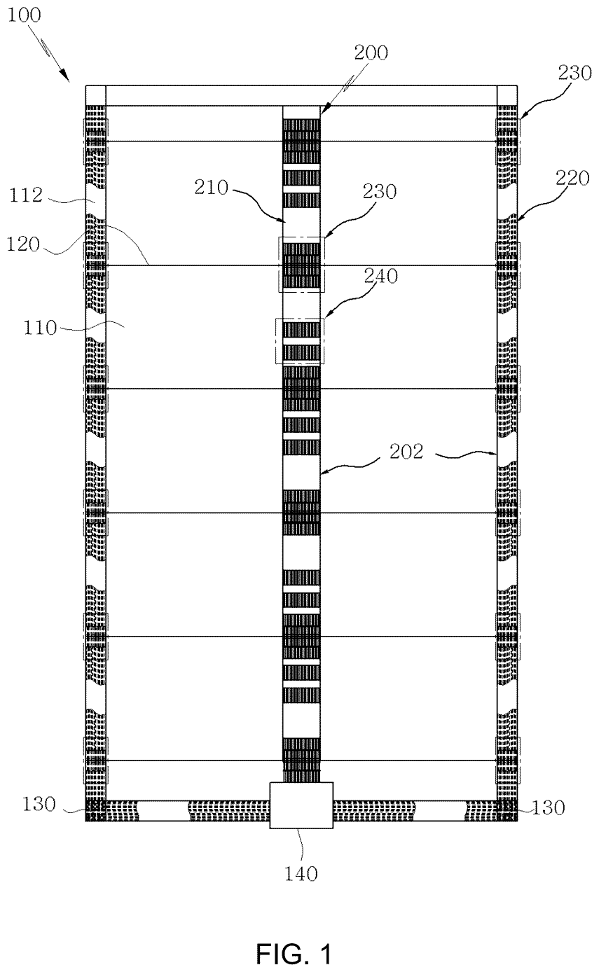

FIG. 2 is a view showing a portion of the fire prevention mat according to one embodiment of the present disclosure.

FIG. 3 is an enlarged view of part “A” according to one embodiment of the present disclosure.

### MODE FOR CARRYING OUT THE INVENTION

Hereinafter, embodiments of the present disclosure will be described in detail with reference to the attached drawings.

As shown, a fire prevention mat of the present disclosure, which comprises a typical sleeping mat, an electric thermal mat layered on a bed mattress to provide heat, or a heating (or thermal) sheet placed in a car seat, is configured to include a mat part 100 and a heating sheet part 200.

The mat part 100 is configured to include a base fabric 110 in which typical fibers are woven to be perpendicular to each other and to which a heating sheet part 200 is combined, a plurality of heating lines 120 that are woven together with the base fabric 110 to be electrically connected with the heating sheet part 200 and generate heat when power is applied thereto, and a control device 140 that controls the application of power to the heating lines 120.

The base fabric 110 is configured to include a second electrode part 220 provided in the heating sheet part 200 along a peripheral surface thereof, and a finishing part 112 formed to support the second electrode part 220 and the heating line 120 so that they can be electrically connected to each other.

In this case, the finishing part 112 may be configured with the same material as the base fabric 110, and may be configured so that ends of the second electrode part 220 and the heating line 120 can be electrically connected to each other internally to prevent the ends of the second electrode part 220 and the heating line 120 from being exposed to the outside, but the present disclosure is not limited thereto.

That is, the second electrode part 220 may be configured to be joined by weaving to an upper surface of the finishing part 112, and when the second electrode part 220 is joined, the heating line 120 may also be configured to be joined by weaving.

In addition, an electrode finishing part 130 is formed on the base fabric 110 at the finishing part 112, preferably, at a portion where a first electrode part 210 and the second electrode part 220 constituting the heating sheet part 200 are connected (or in contact) with each other, thereby joining the first and second electrode parts 210, 220 to the base fabric 110.

In this case, the electrode finishing part 130 may correspond to the portion where the first and second electrode parts 210, 220 are joined by weaving on the finishing part 112.

The heating line 120 is configured to be a plurality of parts spaced apart at a predetermined interval on the upper surface of the base fabric 110, and is configured to be arranged in parallel at the predetermined interval on the base fabric 110, and is configured so that both ends thereof are electrically connected to the first and second electrode parts 210, 220 formed in the heating sheet part 200, and is configured so that heating is generated by power applied to the first and second electrode parts 210, 220.

The heating line 120 may be made of carbon fiber. However, the present disclosure is not limited thereto, and heating line 120 may be configured in a form in which a pair of silver-coated yarns are double-covered while crossing each other.

In this case, double covering means that a silver-coated yarn is wound clockwise around the outer surface of the heating line 120, and another silver-coated yarn is wound counterclockwise, thereby wrapping the outer surface of the heating line 120 while crossing each other.

The heating sheet part 200 is configured to generate heat in the heating line 120 as current applied by the control device 140 flows through it, and is configured to include a first electrode part 210 which is configured to be woven into the base fabric 110 and to be in contact with the heating line 120, and configured so that the contact portion with the heating line 120 is branched to be connected to each other, a second electrode part 220 which is provided on one side or both sides of the base fabric 110, or provided on the peripheral surface, and configured so that both ends of the heating line 120 are in contact with it, a first insulating cover part 230 which is configured on the first electrode part 210 at a position where contact is made with the heating line 120, and which secures the first electrode part 210 to the base fabric 110 and provides insulation against the current flowing through the first electrode part 210, and a second insulating cover part 240 which is configured between the first insulating cover part 230, and which fixes the first electrode part 210 to the base fabric 110 and provides insulation against the current flowing through the first electrode part 210.

The first electrode part 210 is joined to the base fabric 110 by weaving to be formed in a central portion of the base fabric 110, and configured to make contact with a central side of the heating line 120, so that the heating line 120 is heated by the current applied from the control device 140.

In this case, in the present disclosure, the first electrode part 210 is described as being formed in the central portion of the base fabric 110, but the present disclosure is not limited thereto, and depending on the size of the base fabric 110, i.e., the size or area of the fire prevention mat, the first electrode part 210 may be formed on one side of the base fabric 110.

In this case, when the first electrode part 210 is formed on one side of the base fabric 110, the second electrode part 220 may be formed in a position opposite to the first electrode part 210 so that both ends of the heating line 120 are in contact with them, respectively.

The first electrode part 210 is comprised of a plurality of conductive lines 250 formed of a copper wire (or copper thread) coated with tin on the surface and spaced apart at fine intervals, and a plurality of branch conductive lines 260 that divide the plurality of conductive lines 250 into a certain number of strands to branch them and connect the branched plurality of conductive lines 250 to each other.

In this case, the conductive line 250 may be formed of a plurality of copper wires coated with tin, and the conductive line 250 formed of the plurality of copper wires is provided in plurality, which increases the contact area with the heating line 120 and prevents poor contact with the heating line 120.

For example, one of the plurality of conductive lines 250 of the present disclosure may be formed of 32 copper wires coated with tin. However, the present disclosure is not limited thereto, and the number of copper wires forming one conductive line 250 may be applied differently depending on the size and area of the fire prevention mat.

The branch conductive lines 260 are formed on each of the plurality of conductive lines 250 and are formed at a position spaced apart by a predetermined distance from the portion in contact with the heating line 120. The branch conductive lines 260 divide the copper wires forming the plurality of conductive lines 250 into a predetermined number of strands to branch them and connects the branched copper wires to each other so that all of the conductive lines 250 can be maintained in a state where they are all electrically conductive, thereby maximizing the contact area between the plurality of conductive lines 250 and the heating line 120 to prevent poor contact with the heating line 120, and preventing a fire from occurring due to poor contact with the heating line 120 even if some or most of the copper wires forming the plurality of conductive lines 250 are damaged or broken.

The branch conductive lines 260 are configured so that when connecting the plurality of conductive lines 250, the branch conductive lines 260 formed at opposing positions are connected to each other.

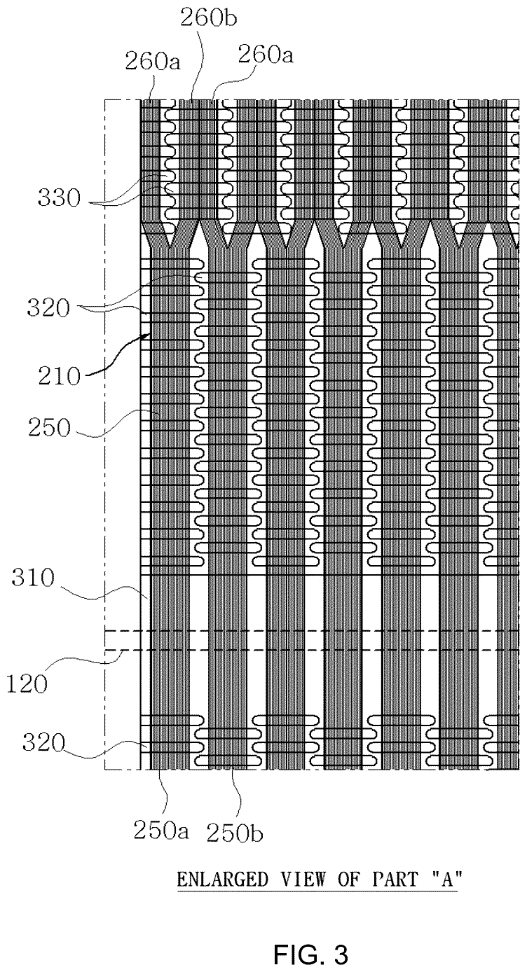

That is, as illustrated in FIG. 3, the branch conductive line 260 branches from the conductive line 250 into a first branch conductive line 260a and a second branch conductive line 260b, and when connecting a first conductive line 250a and a second conductive line 250b among the plurality of conductive lines 250 branched into the first and second branch conductive lines 260a, 260b, the second branch conductive line 260b formed in the first conductive line 250a is connected to the first branch conductive line 260a formed in the second conductive line 250b.

Meanwhile, when one conductive line 250 is made of 32 tin-coated copper wires as in the above-described example, the branch conductive lines 260 of the present disclosure may be formed as the first and second branch conductive lines 260a, 260b each made of 16 copper wires, but the present disclosure is not limited thereto.

With such configurations, the present disclosure can maintain a state in which a plurality of conductive lines 250 are connected to each other by the branch conductive lines 260, and since the plurality of conductive lines 250 connected by the branch conductive lines 260 are configured to be integrated with each other, even if a disconnection occurs in many of the copper wires forming the conductive lines 250 and poor contact with the heating line 120 occurs, the flow of current applied can be maintained through other copper wires that are stably maintaining contact with the heating line 120.

In other words, the present disclosure can solve the conventional problem that since the plurality of conductive lines 250 are independently configured and woven into the base fabric 110, if some of the copper wires forming the conductive lines 250 are disconnected, resulting in poor contact with the heating line 120, and only a small number of copper wires are in contact with the heating line 120, resistance is concentrated on the small number of copper wires, which leads to overheating, transferring to the disconnected copper wires, and occurrence of a fire.

Meanwhile, the second electrode part 220 of the present disclosure is formed on the finishing part 112 of the base fabric 110 and is configured so that the ends of the heating line 120 can make contact, and is configured to have the same form as the first electrode part 210 described above.

That is, the second electrode part 220 is also comprised of a plurality of conductive lines 250 formed of a copper wire (or copper thread) coated with tin on the surface and spaced apart at fine intervals, and a plurality of branch conductive lines 260 that divide the plurality of conductive lines 250 into a certain number of strands to branch them and connect the branched plurality of conductive lines 250 to each other.

The first insulating cover part 230 is a component that is provided in an electrode part 202 including the first electrode part 210 or the first and second electrode parts 210, 220, supports electrical contact between the heating line 120 and the plurality of conductive lines 250, and provides insulation to the electrode part 202 by covering the plurality of conductive lines 250 to surround them, while covering the connection portions of the branch conductive lines 260 formed at each of the plurality of conductive lines 250 to surround them to ensure coupling to the base fabric 110.

The first insulating cover part 230 may be configured in multiple pieces spaced apart at a predetermined interval along the electrode part 202, and may be configured to be orthogonal to the heating line 120 arranged in parallel on the base fabric 110.

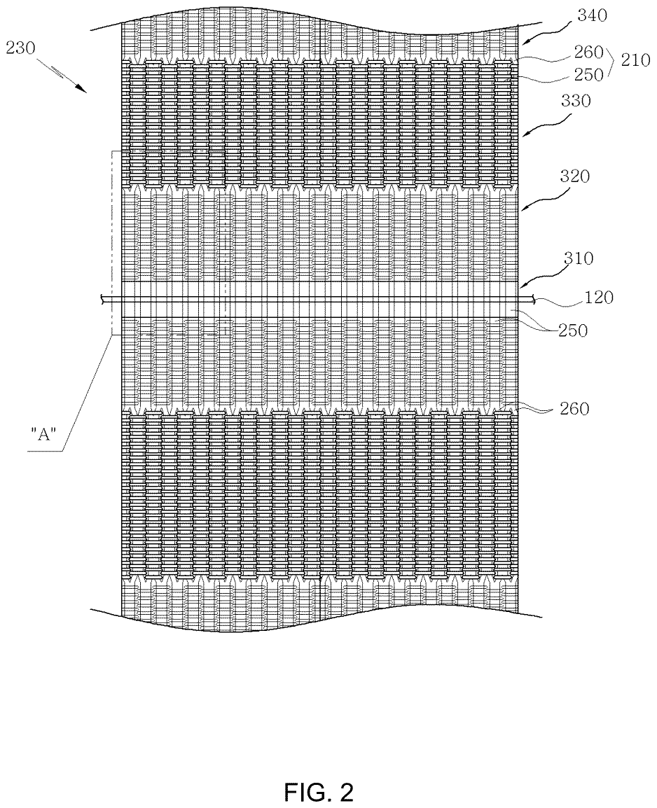

As shown in FIGS. 2 and 3, the first insulating cover part 230 is configured to include an electrode contact part 310 in which a space is provided so that the heating line 120 is disposed orthogonally to the plurality of conductive lines 250, and electrical contact can be made between the heating line 120 and the plurality of conductive lines 250, a first electrode covering part 320 which is provided on each of upper and lower sides of the electrode contact part 310 and covers the plurality of conductive lines 250 that are in electrical contact with the heating line 120 and secure them to the base fabric 110, and a branch conductive line connecting part 330 which is provided on each of upper and lower sides of the first electrode covering part 320 and connects the plurality of branch conductive lines 260 formed on the plurality of conductive lines 250 so that the plurality of conductive lines 250 can be integrated with each other.

In addition, the first insulating cover part 230 may further include a second electrode covering part 340 which is provided on each of upper and lower sides of the branch conductive line connecting part 330, covers the plurality of conductive lines 250 extending from the ends of the branch conductive lines 260, secures the plurality of conductive lines 250 to the base fabric 110, and provides insulation against the current flowing through the plurality of conductive lines 250.

Furthermore, the first insulating cover part 230 of the present disclosure may be formed of a blended yarn in which carbon fiber yarn and stretchable yarn, such as spandex yarn, high-elasticity urethane yarn, or the like are mixed, and is configured to wrap the electrode part 202, and both ends thereof are formed by weaving together on the base fabric 110.

The first insulating cover part 230 of the present disclosure configured in this manner enables easier and better contact between the base fabric 110 and the heating line 120, while maximizing the electrode contact points with the electrode part 202 and stably maintaining the electrical connection state.

In addition, it can provide structural stability between the electrode part 202 and the base fabric 110, thereby providing resistance to stress due to repeated loads caused by repeated use of the fire prevention mat, and thus, even if washing is performed using a general washing method such as hand washing or water washing, damage or breakage of the conductive lines can be minimized.

The second insulating cover part 240 is provided between the plurality of first insulating cover parts 230, covers the electrode part 202 including the first and second electrode parts 210, 220 which are comprised of the plurality of conductive lines 250 and branch conductive lines 260 arranged between the first insulating cover parts 230, and serves to secure the electrode part 202 to the base fabric 110 and provide insulation against the current flowing through the electrode part 202.

The second insulating cover part 240 may be comprised of first and second electrode covering parts 320, 340 provided in the first insulating cover part 230.

That is, the second insulating cover part 240 is comprised of the first electrode covering part 320 that covers the heating line 120 and the plurality of conductive lines 250 to surround them, and the second electrode covering part 340 that is provided on a lower side of the first electrode covering part 320 and covers the plurality of conductive lines 250 that extend from the ends of the plurality of branch conductive lines 260 to surround them.

The above description is merely an illustrative description of the technical idea of the present disclosure, and various modifications and variations may be made without departing from the essential characteristics of the present disclosure by those skilled in the art to which the present disclosure pertains. Accordingly, the embodiments disclosed in the present disclosure are not intended to limit the technical idea of the present disclosure but to explain it, and the scope of the technical idea of the present disclosure is not limited by these embodiments. The protection scope of the present disclosure should be interpreted by the following claims, and all technical ideas within a scope equivalent thereto should be interpreted as being included in the scope of the present disclosure.

### REFERENCE NUMERALS FREE TEXT

100: mat part 110: base fabric
112: finishing part 120: heating line
130: electrode finishing part 140: control device
200: heating sheet part 210: first electrode part
220: second electrode part 230: first insulating cover part
240: second insulating cover part 250: conductive line
260: branch conductive line 310: electrode contact part
320: first electrode covering part 330: branch conductive line connecting part
340: second electrode covering part

What is claimed is:

1. A fire prevention mat comprising:
a base fabric (110) provided with a control device (140) for controlling supply of direct current power;
a plurality of heating lines (120) that are coupled to the base fabric (110) and generate heat when power is applied thereto; and
an electrode part (202) including a plurality of conductive lines (250) configured to make electrical contact with the heating lines (120), and a plurality of branch conductive lines (260) provided in the plurality of conductive lines (250), which divide copper wires forming the plurality of conductive lines (250) into a predetermined number of strands to branch them and connect the branched plurality of conductive lines (250) to each other to be electrically connected.

2. The fire prevention mat of claim 1, wherein the electrode part (202) includes:
a first electrode part (210) comprised of the plurality of conductive lines (250) and the plurality of branch conductive lines (260), provided in a central portion of the base fabric (110), and configured to contact the central portion of the heating line (120);
a second electrode part (220) which is provided on one side or both sides of the base fabric (110) or is provided on a peripheral surface thereof, and is configured to contact both ends of the heating line (120);
a plurality of first insulating cover parts (230) provided on the first electrode part (210) at positions where the heating line (120) and the plurality of conductive lines (250) come into contact to secure the first electrode part (210) to the base fabric (110); and
a second insulating cover part (240) provided between the plurality of first insulating cover parts (230) to provide insulation against the current flowing through the first electrode part (210).

3. The fire prevention mat of claim 2, wherein the plurality of conductive lines (250) are comprised of a plurality of tin-coated copper wires.

4. The fire prevention mat of claim 2, wherein each of the branch conductive lines (260) branches from each of the plurality of conductive lines (250) into a first branch conductive line (260a) and a second branch conductive line (260b).

5. The fire prevention mat of claim 2, wherein the first insulating cover part (230) includes:
an electrode contact part (310) that allows the heating line (120) and the plurality of conductive lines (250) to be electrically contacted while being orthogonal to each other;
a first electrode covering part (320) that is provided on each of upper and lower sides of the electrode contact part (310) and covers the heating line (120) and the plurality of conductive lines (250) to surround them;
a branch conductive line connecting part (330) that is provided on each of upper and lower sides of the first electrode covering part (320) and connects the plurality of branch conductive lines (260) formed on the plurality of conductive lines (250); and
a second electrode covering part (340) that is provided on each of upper and lower sides of the branch conductive line connecting part (330) and covers the plurality of conductive lines (250) extending from ends of the plurality of branch conductive lines (260) to surround them.

6. The fire prevention mat of claim 2, wherein the second insulating cover part (240) includes:
a first electrode covering part (320) that covers the heating line (120) and the plurality of conductive lines (250); and
a second electrode covering part (340) that is provided on a lower side of the first electrode covering part (320) and covers the plurality of conductive lines (250) that extend from ends of the plurality of branch conductive lines (260).
